(19) United States
(12) Patent Application Publication
(10) Pub. No.: US 2026/0194917 A1
(43) Pub. Date: Jul. 9, 2026

(54) AUTOMATED GUIDED VEHICLE, AND METHOD OF CONTROLLING AUTOMATED GUIDED VEHICLE

(71) Applicant: ABB Schweiz AG, Baden (CH)

(72) Inventor: Jonas Larsson, Västerås (SE)

(73) Assignee: ABB Schweiz AG, Baden (CH)

(21) Appl. No.: 19/556,643

(22) Filed: Mar. 4, 2026

Related U.S. Application Data
(63) Continuation of application No. PCT/EP2023/075404, filed on Sep. 15, 2023.

(51) Int. Cl. G05D 1/672; B25J 9/16; G05D 109/18; G05D 111/50

(52) U.S. Cl. CPC G05D 1/672; B25J 9/162; G05D 2109/18; G05D 2111/58

(57) ABSTRACT

An automated guided vehicle (AGV), comprising a main unit including a main body and a plurality of main wheels supporting the main body, at least one of the main wheels being a traction wheel; an auxiliary unit including an auxiliary body and at least one auxiliary wheel supporting the auxiliary body; and a hinge connected between the main body and the auxiliary body such that the auxiliary body can rotate relative to the main body about a horizontal hinge axis; wherein the AGV is configured such that a center of mass of the auxiliary unit is horizontally offset from the hinge axis when the main body and the auxiliary unit are supported on a common horizontal surface; and wherein the AGV is configured to determine a rotational position of the auxiliary body relative to the main body about the hinge axis.

### CROSS-REFERENCE TO RELATED APPLICATIONS

The instant application claims priority to International Patent Application No. PCT/EP2023/075404, filed September 15, 2023, which is incorporated herein in its entirety by reference.

### FIELD OF THE DISCLOSURE

The present disclosure generally relates to automated guided vehicles (AGVs) and, more particularly, to an AGV and a method of controlling an AGV.

### BACKGROUND OF THE INVENTION

Automated guided vehicles, AGVs, are typically self-powered, self-driven vehicles. AGVs may be used to transport materials and other items from one location to another, without the need for a driver on the vehicle. An AGV may also comprise a manipulator for performing various tasks. AGVs are commonly used in manufacturing sites, warehouses, post offices, libraries, port terminals, airports, and some hazardous locations and specialty industries.

EP 2573040 A1 discloses an automated guided vehicle, AGV, for towing a trolley. The AGV comprises a first body portion, a second body portion, drive wheels and support wheels. The trolley comprises castor wheels. The AGV engages the trolley by means of a latch mechanism having an adapter plate. The latch mechanism is operated by the movement of the AGV into contact with the trolley, or by an electromechanical actuator, to fasten the trolley and vehicle together.

### BRIEF SUMMARY OF THE INVENTION

In some applications, it is desirable to use an AGV to provide a support surface for supporting a payload to be handled by a manipulator, such as a robotic arm. In particular, this desire may be present in case the AGV itself comprises the manipulator. When the support surface is provided on a main unit of the AGV, the space and load capacity provided for the payload is often limited. If the main unit is manufactured at a size for a specifically intended payload, the main unit may be too small or too large for payloads other than the intended payload leading to an inferior cost-efficiency.

In order to provide an increased cost-efficiency and versatility of the AGV, the AGV may be provided with an auxiliary unit detachably coupled to the main unit, where a support surface for a payload is provided on the auxiliary unit. In this way, the space and load capacity provided by the AGV can be increased.

In EP 2573040 A1, if the trolley is fixed with respect to the AGV in, the orientation of the trolley relative to the AGV may be known but the AGV will exhibit inferior navigation performance on uneven ground surfaces. For example, some of the wheels may lose contact with an uneven ground surface. Assuming on the other hand that some relative motion is possible between the AGV and the trolley in EP 2573040 A1, the trolley can be inclined relative to the AGV when travelling on an uneven surface but the orientation of the trolley relative to the AGV would not be known. Such relative motion may for example occur due to suspension and/or play between mechanical components. When the orientation of an auxiliary unit of an AGV is not known, a manipulator is prevented from blindly handling objects thereon, i.e., without using some means to detect the positions of the objects on a case-by-case basis, such as a camera.

The present disclosure generally describes improved AGV and an improved method of controlling an AGV.

Embodiments in accordance with the present disclosure include an AGV comprising a main unit and an auxiliary unit connected to the main unit, where the auxiliary unit is rotatable relative to the main unit only about a horizontal hinge axis, and where the AGV is configured to determine a rotational position of the auxiliary body relative to the main body about the hinge axis, the AGV provides an improved performance and versatility.

According to a first aspect, there is provided an automated guided vehicle, AGV, comprising a main unit including a main body and a plurality of main wheels supporting the main body, at least one of the main wheels being a traction wheel; an auxiliary unit including an auxiliary body and at least one auxiliary wheel supporting the auxiliary body; and a hinge connected between the main body and the auxiliary body such that the auxiliary body can rotate relative to the main body about a horizontal hinge axis; wherein the AGV is configured such that a center of mass of the auxiliary unit is horizontally offset from the hinge axis when the main body and the auxiliary unit are supported on a common horizontal surface; and wherein the AGV is configured to determine a rotational position of the auxiliary body relative to the main body about the hinge axis.

The hinge provides a single degree of freedom between the main body and the auxiliary body, namely a rotation about the hinge axis. By determining the rotational position of the auxiliary body, the rotational position can be included as a variable when controlling a manipulator to handle objects carried by the auxiliary body. In this way, any relative rotation between the auxiliary body and the main body around the hinge axis can be online compensated for in a computer program for controlling the manipulator. The AGV may determine the rotational position of the auxiliary body when the AGV is at standstill.

### BRIEF DESCRIPTION OF THE SEVERAL VIEWS OF THE DRAWING(S)

FIG. 1 is a diagram of a side view of an AGV in accordance with the present disclosure.

FIG. 2 is a diagram of a top view of the AGV of FIG. 1.

FIG. 3 is a diagram of another side of the AGV in FIGS. 1 and 2, wherein a main body is supported on a horizontal surface and an auxiliary body is supported on an inclined surface, in accordance with the disclosure.

FIG. 4 is a diagram of a side view of an AGV according to a further example and a manipulator external to the AGV, in accordance with the disclosure.

FIG. 5 is a diagram of a top view of an AGV according to a further example of the present disclosure.

FIG. 6 is a diagram of a side view of an AGV according to a further example of the present disclosure.

FIG. 7 is a diagram of a top view of an AGV according to a further example of the present disclosure.

### DETAILED DESCRIPTION OF THE INVENTION

In the following, an automated guided vehicle, AGV, and a method of controlling an AGV, will be described. The same or similar reference numerals will be used to denote the same or similar structural features.

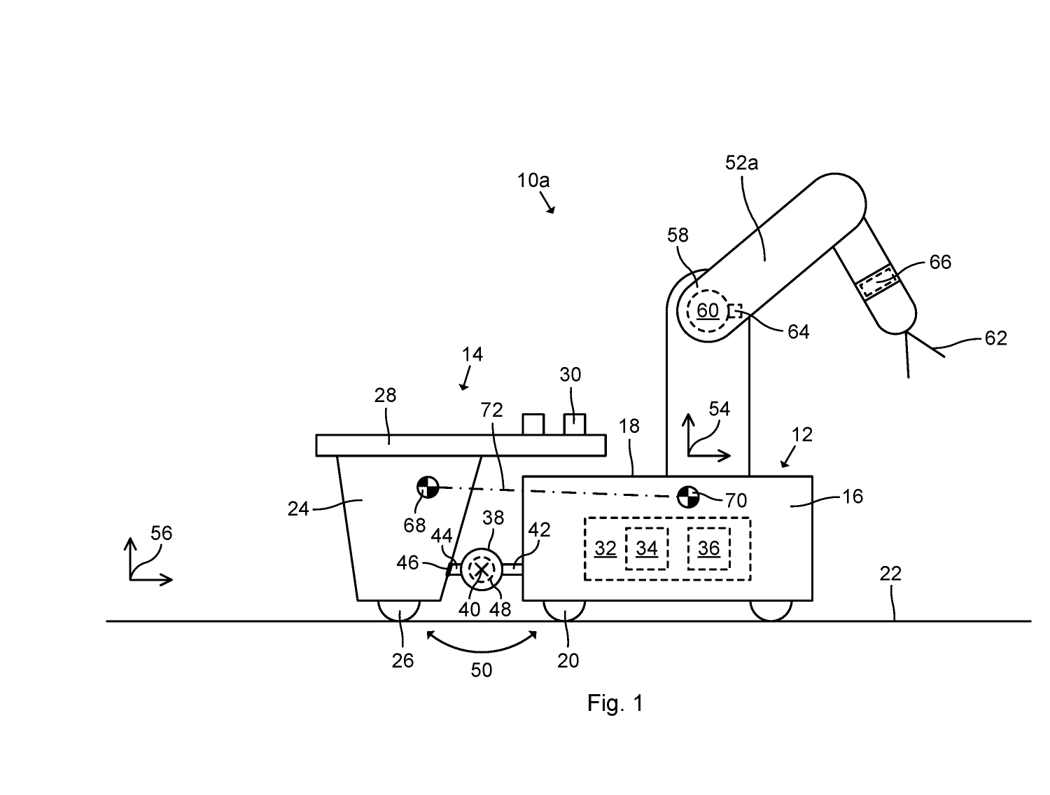

FIG. 1 schematically represents a side view of an automated guided vehicle, AGV, 10a. The AGV 10a comprises a main unit 12 and an auxiliary unit 14 connected to the main unit 12.

The main unit 12 comprises a main body 16. The main body 16 comprises a main platform 18 provided at an upper portion of the main body 16. The main unit 12 of this example further comprises a plurality of main wheels 20. The main wheels 20 support the main body 16 on a horizontal surface 22, such as a floor. The AGV 10a of this example comprises four main wheels 20 (only two are shown in FIG. 1). Each main wheel 20 is a steerable traction wheel in this example.

The auxiliary unit 14 comprises an auxiliary body 24. The auxiliary unit 14 of this example comprises a single auxiliary wheel 26. The auxiliary wheel 26 supports the auxiliary body 24 on the horizontal surface 22. The auxiliary wheel 26 of this example is a passive wheel, here a castor wheel.

The auxiliary body 24 of this example comprises an auxiliary platform 28, here exemplified as a table, for carrying a payload. The auxiliary platform 28 is one example of an auxiliary support structure according to the present disclosure. A plurality of items 30 are positioned on the auxiliary platform 28. The items 30 constitute one example of a payload. As shown in FIG. 1, the auxiliary platform 28 partly overlaps the main platform 18. One or more items 30 can also be positioned on the main platform 18, at least when the auxiliary unit 14 is not connected to the main unit 12.

The AGV 10a comprises an electronic control system 32. The control system 32 of this example comprises a data processing device 34 and a memory 36. The memory 36 has a computer program stored therein. The computer program comprises program code which, when executed by the data processing device 34, causes the data processing device 34 to perform, or command performance of, various steps of the AGV 10a as described herein. In this example, the control system 32 is provided in the main body 16.

The AGV 10a further comprises a hinge 38 connected between the main body 16 and the auxiliary body 24. The hinge 38 is here connected to each of the main body 16 and the auxiliary body 24. The hinge 38 provides a mechanical interface between the main unit 12 and the auxiliary unit 14. The hinge 38 may as such be a commercially available hinge. In this example, all main wheels 20 are positioned horizontally on a common side (to the right in FIG. 1) of the hinge 38.

The hinge 38 defines a horizontal hinge axis 40 around which the main body 16 and the auxiliary body 24 can undergo relative rotation. This relative rotation is the only degree of freedom between the auxiliary body 24 and the main body 16 in this example. When the entire AGV 10a is positioned on the horizontal surface 22, the auxiliary platform 28 of this example is horizontal.

The hinge 38 of this example comprises a main hinge part 42 and an auxiliary hinge part 44. The main hinge part 42 is fixed to the main body 16 and the auxiliary hinge part 44 is fixed to the auxiliary body 24.

The AGV 10a of this example comprises a connection interface 46 for detachable connection between the main unit 12 and the auxiliary unit 14. In this example, the connection interface 46 is provided between the auxiliary unit 14 and the hinge 38, more specifically between the auxiliary body 24 and the auxiliary hinge part 44. The connection interface 46 may alternatively be provided between the hinge 38 and the main unit 12. The connection interface 46 may comprise fasteners (not shown), to mechanically connect the auxiliary unit 14 to the main unit 12. Since the auxiliary wheel 26 is a passive wheel and since the auxiliary unit 14 does not require electric power, the connection interface 46 of this example is purely mechanical.

The AGV 10a of this example further comprises an auxiliary sensor 48. The auxiliary sensor 48 is arranged to provide rotation data indicative of a rotational position 50 of the auxiliary body 24 relative to the main body 16 about the hinge axis 40. The AGV 10a is thus arranged to determine the rotational position 50. The auxiliary sensor 48 is in signal communication with the control system 32 and the rotation data from the auxiliary sensor 48 is sent to the control system 32. The auxiliary sensor 48 of this example is integrated in the hinge 38.

The AGV 10a of this example further comprises a manipulator 52a, here exemplified as a serial robotic arm programmable in three or more axes, such as in six or seven axes. The AGV 10a is thus an automated mobile manipulator robot, AMMR. FIG. 1 further shows an AGV coordinate system 54. The manipulator 52a is controlled by the control system 32. The manipulator 52a may be controlled in the AGV coordinate system 54 to perform various tasks. The control system 32 also controls the driving of the main wheels 20. Moreover, the control system 32 keeps track of a position of the AGV 10a in a global coordinate system 56 in a known manner, for example using odometry, triangulation and/or lidar (light detection and ranging).

The manipulator 52a is supported on the main body 16, here on the main platform 18 thereof. The manipulator 52a comprises a plurality of joints 58 (one for each axis) and an actuator 60 at each joint 58 for driving the respective joint 58. Each joint 58 may be either rotational or translational. The manipulator 52a of this example further comprises an end effector 62, here exemplified as a gripper.

The manipulator 52a of this example further comprises an encoder 64 at each joint 58 and a force sensor 66. Each encoder 64 is arranged to determine a position of the associated joint 58 and the force sensor 66 is arranged to sense a force in the manipulator 52a. Corresponding data is sent to the control system 32.

FIG. 1 further shows a center of mass 68 of the auxiliary unit 14 and a center of mass 70 of the main unit 12. In this example, the center of mass 68 of the auxiliary unit 14 is determined without any payload thereon, while the center of mass 70 of the main unit 12 is determined with the manipulator 52a thereon. That is, the center of mass 70 of the main unit 12 represents a combined center of mass 70 of the main unit 12 and the manipulator 52a. As shown in FIG. 1, the center of mass 68 of the auxiliary unit 14 is horizontally offset from the hinge axis 40 when the AGV 10a is supported on the horizontal surface 22. Moreover, FIG. 1 shows that the hinge axis 40 is positioned transverse to a line 72 between the centers of mass 68 and 70.

In some applications, the AGV 10a may need a small footprint. In such cases, the AGV 10a may be operated with only the main unit 12, i.e., without the auxiliary unit 14. In some other applications, the AGV 10a may be required to carry a heavy payload on a large support structure, such as more than 150 kg. In such cases, the AGV 10a may be operated together with the auxiliary unit 14 to meet the payload requirement. The AGV 10a thus has a modular and versatile design.

A horizontal distance between the auxiliary wheel 26 and the hinge axis 40 will determine how the load of the auxiliary unit 14 affects the main unit 12. If the center of mass 68 of the auxiliary unit 14 is positioned horizontally between the auxiliary wheel 26 and the hinge axis 40, like in FIG. 1, the auxiliary unit 14 will provide a downward force on the main wheels 20 closest to the hinge axis 40. If on the other hand the auxiliary wheel 26 is positioned between the center of mass 68 of the auxiliary unit 14 and the hinge axis 40, the auxiliary unit 14 will provide an upward force on the main wheels 20 closest to the hinge axis 40.

The manipulator 52a can handle each item 30 on the auxiliary platform 28, for example by picking an item 30 from the auxiliary platform 28, placing an item 30 on the auxiliary platform 28, or performing an operation on the item 30 while positioned on the auxiliary platform 28. The handling of the items 30 by the manipulator 52a on the auxiliary platform 28 may be performed when the AGV 10a is at standstill. In order for the manipulator 52a to pick, place, or otherwise handle the items 30 on the auxiliary platform 28, the position of each item 30 in the AGV coordinate system 54 must be known by the control system 32. The AGV 10a can determine these positions based on the rotational position 50.

Different applications may impose different requirements on size and payload capacity of the AGV 10a. Since the auxiliary unit 14 can be replaced with an auxiliary unit 14 of a different type (e.g., for handling a larger payload), the AGV 10a can be upgraded to efficiently address this problem while requiring a minimum number of different types of main units 12 and auxiliary units 14. An end user may for example provide the AGV 10a and a portfolio of different auxiliary units 14 and select one of the auxiliary units 14 for connection to the main unit 12 depending on tasks to be performed by the AGV 10a. A single auxiliary unit 14 may also be used with different types of main units 12.

Since the AGV 10a can carry a payload also on the main platform 18, the AGV 10a can be used without the auxiliary unit 14 for small and light payloads and can be used together with the auxiliary unit 14 for larger and/or heavier payloads. In this way, the main wheels 20 do not have to be dimensioned for the AGV 10a to carry a heavy payload without the auxiliary unit 14. This greatly improves cost-efficiency of the AGV 10a.

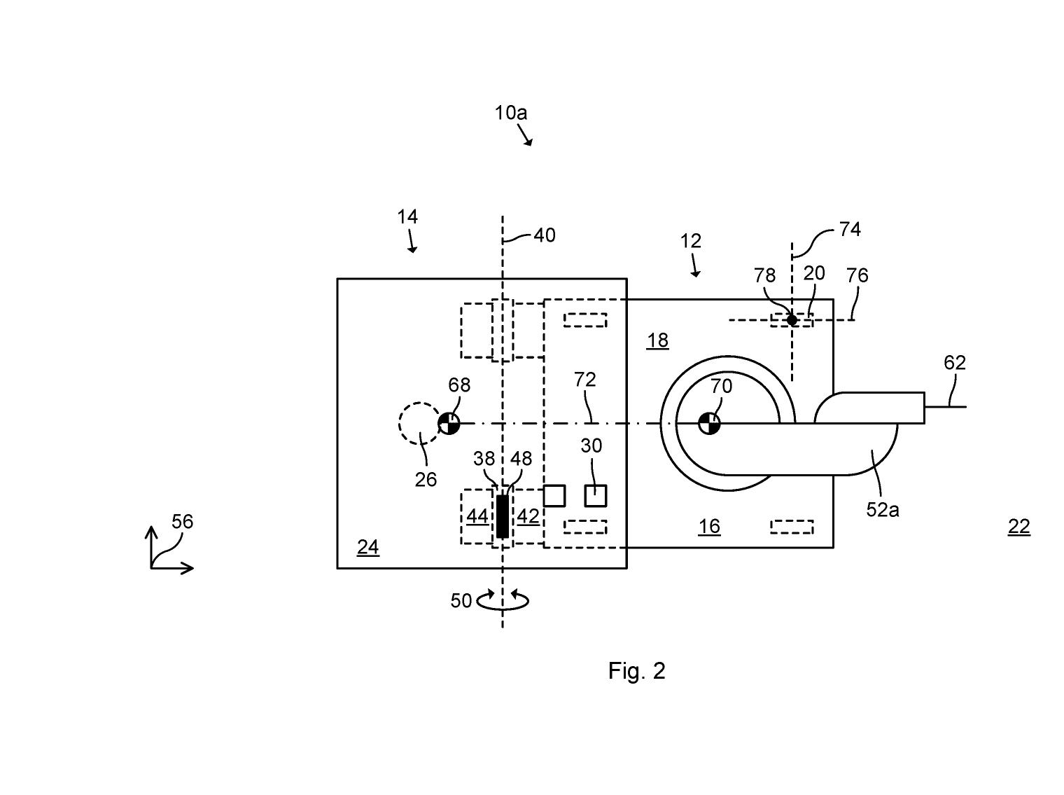

FIG. 2 schematically represents a top view of the AGV 10a. As shown in FIG. 2, the AGV 10a of this example comprises two concentric hinges 38. The AGV 10a may thus comprise one or a plurality of concentric hinges 38. Each hinge 38 is connected between the main body 16 and the auxiliary body 24 such that the auxiliary body 24 can rotate relative to the main body 16 about the hinge axis 40. For the purpose of the present application, only one hinge 38 needs to be described.

In this example, each main wheel 20 comprises a drive motor (not illustrated) for driving the main wheel 20 to rotate around a horizontal wheel axis 74 such that the main wheel 20 is driven in a heading direction 76. In this example, each main wheel 20 also comprises a steering motor (not illustrated) for driving the main wheel 20 to rotate around a vertical steering axis 78.

Due to the configuration of the main wheels 20, the entire AGV 10a, including both the main unit 12 and the auxiliary unit 14, can perform an omnidirectional motion on the horizontal surface 22 as a single unit. The AGV 10a can for example be instantly driven in an arbitrary horizontal direction and can be rotated on the spot, such as around a geometric center point of the entire AGV 10a. An omnidirectional motion of the AGV 10a can alternatively be achieved by using Swedish wheels.

Moreover, as can be gathered from FIG. 2, the four main wheels 20 of the main unit 12 enable the main unit 12 to travel over the horizontal surface 22 also when the auxiliary unit 14 is disconnected therefrom. The main unit 12 is thus independently stable.

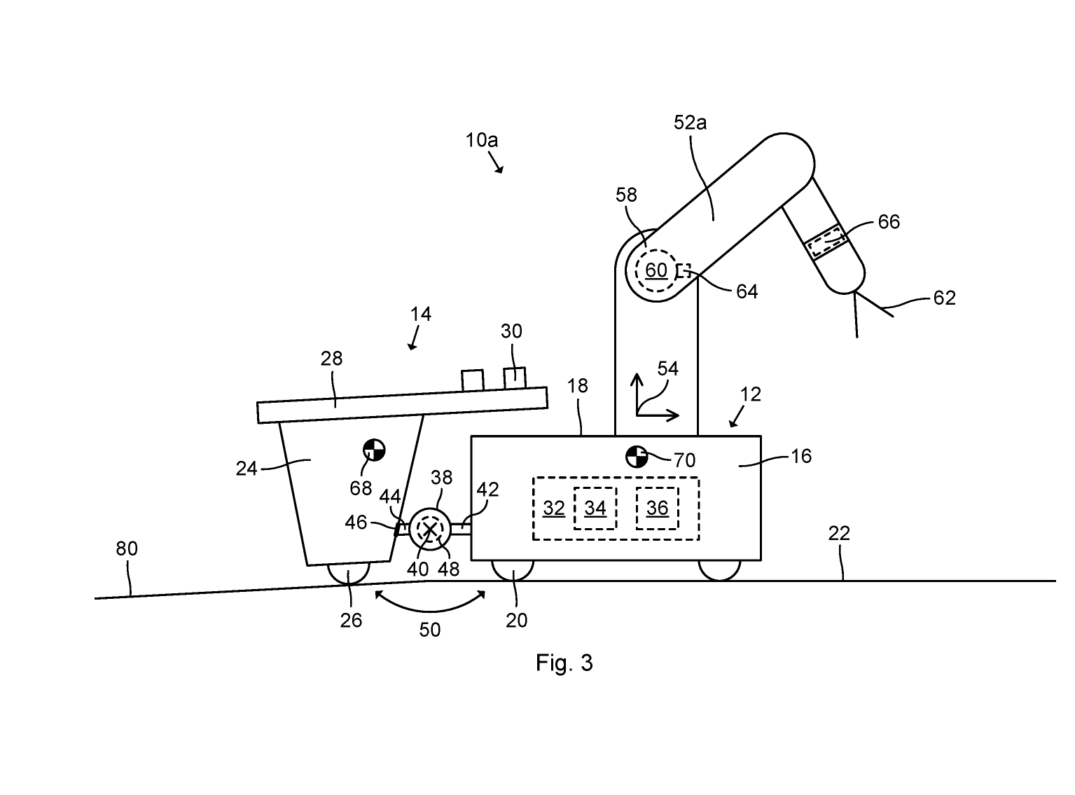

FIG. 3 schematically represents a further side view of the AGV 10a. In FIG. 3, the AGV 10a is at standstill while the main body 16 is supported on the horizontal surface 22 and the auxiliary body 24 is supported on an inclined surface 80.

The auxiliary body 24 may rotate relative to the main body 16 around the hinge axis 40 due to various reasons. One reason for such rotation is that the AGV 10a is positioned on a non-even ground surface. A further reason for such rotation is due to suspension of the main wheels 20 and the auxiliary wheel 26, and non-rigidity of tires thereof. A further reason for such rotation may be a current load distribution on the AGV 10a, where such load may comprise the manipulator 52a and the payload on the auxiliary platform 28.

Picking and placing items 30 on the auxiliary platform 28 may require submillimeter accuracy of the manipulator 52a. By knowing the rotational position 50 of the auxiliary body 24 relative to the main body 16 about the hinge axis 40, the manipulator 52a can blindly handle the items 30 on the auxiliary platform 28 even when the AGV 10a is parked on an uneven ground surface causing relative inclination between the auxiliary body 24 and the main body 16. Thus, a more efficient operation of the AGV 10a is enabled.

The position of the hinge axis 40 in the AGV coordinate system 54 is known to the control system 32, for example by measurements. Moreover, the geometric relationship between the hinge axis 40 and the auxiliary platform 28 currently connected to the main unit 12 is also known to the control system 32, for example by measurements. Based on the position of the hinge axis 40 in the AGV coordinate system 54, the geometric relationship between the hinge axis 40 and the auxiliary platform 28, and the rotational position 50 of the auxiliary body 24 relative to the main body 16 about the hinge axis 40, the control system 32 calculates the position and orientation of the auxiliary platform 28 in the AGV coordinate system 54. The control system 32 can thereby update the positions of the items 30 on the auxiliary platform 28 in the AGV coordinate system 54.

As an alternative or complement to using the auxiliary sensor 48 to determine the rotational position 50, the manipulator 52a can be used. In the example in FIG. 3, the manipulator 52a can for example be controlled to bring the end effector 62 into contact with three unique and non-collinear points on the auxiliary platform 28. Since the auxiliary platform 28 of this example comprises a flat support surface, the control system 32 can calculate the orientation of the auxiliary platform 28 in the AGV coordinate system 54 based on these three unique points. Signals from the encoders 64 and/or from the force sensor 66 may be used by the control system 32 to determine when the end effector 62 contacts the auxiliary platform 28.

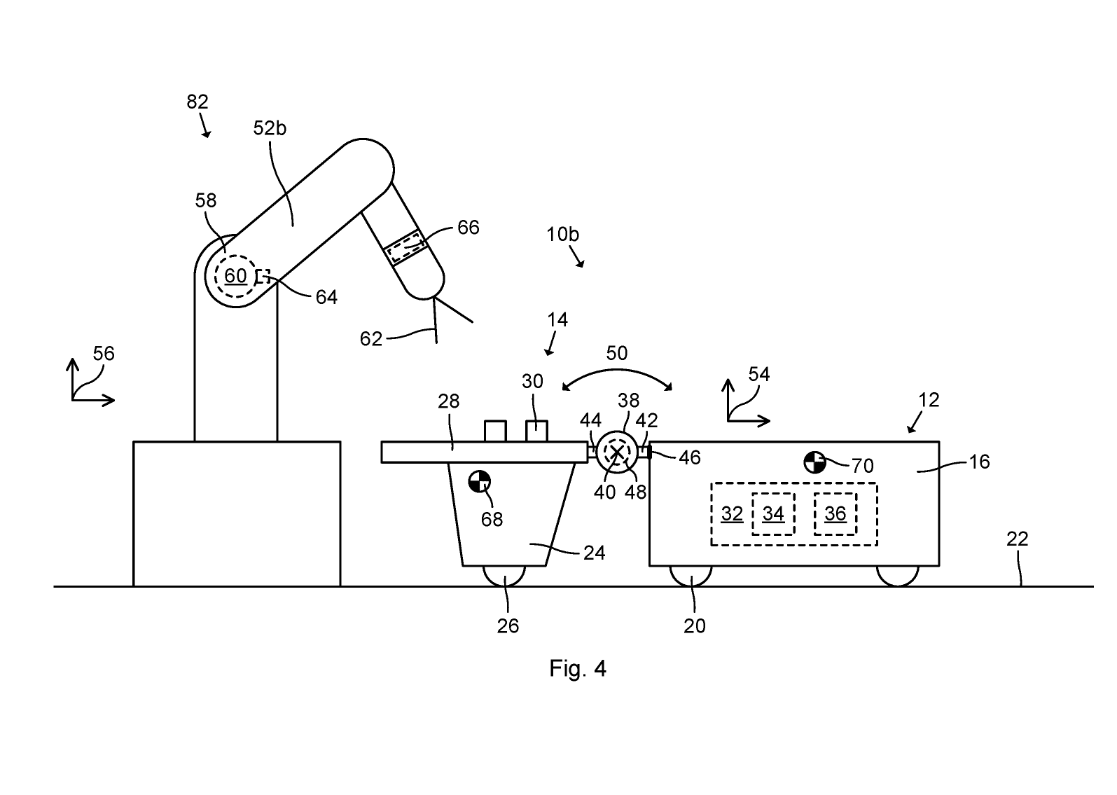

FIG. 4 schematically represents a side view of an AGV 10b according to a further example. Mainly differences from the AGV 10a will be described. The AGV 10b is an automated mobile robot, AMR, that does not comprise a manipulator. Moreover, the auxiliary wheel 26 is positioned between the center of mass 68 of the auxiliary unit 14 and the hinge axis 40. The auxiliary unit 14 of this example therefore provides an upward force on the main wheels 20 closest to the hinge axis 40. In this example, the connection interface 46 is arranged between the main hinge part 42 and the main body 16.

FIG. 4 further shows an industrial robot 82 comprising a manipulator 52b. The manipulator 52b is an external manipulator that does not move together with the AGV 10b. Since the AGV 10b can determine the position and orientation of the auxiliary platform 28 and the items 30 thereon in the AGV coordinate system 54, and since the AGV 10b knows its position in the global coordinate system 56, the position and orientation of the auxiliary platform 28 and the items 30 thereon can be determined in the global coordinate system 56 by the AGV coordinate system 54 and this information can be communicated to the industrial robot 82. The manipulator 52b can thereby be controlled to handle the items 30 on the auxiliary platform 28 blindly even if the auxiliary body 24 is rotated relative to the main body 16.

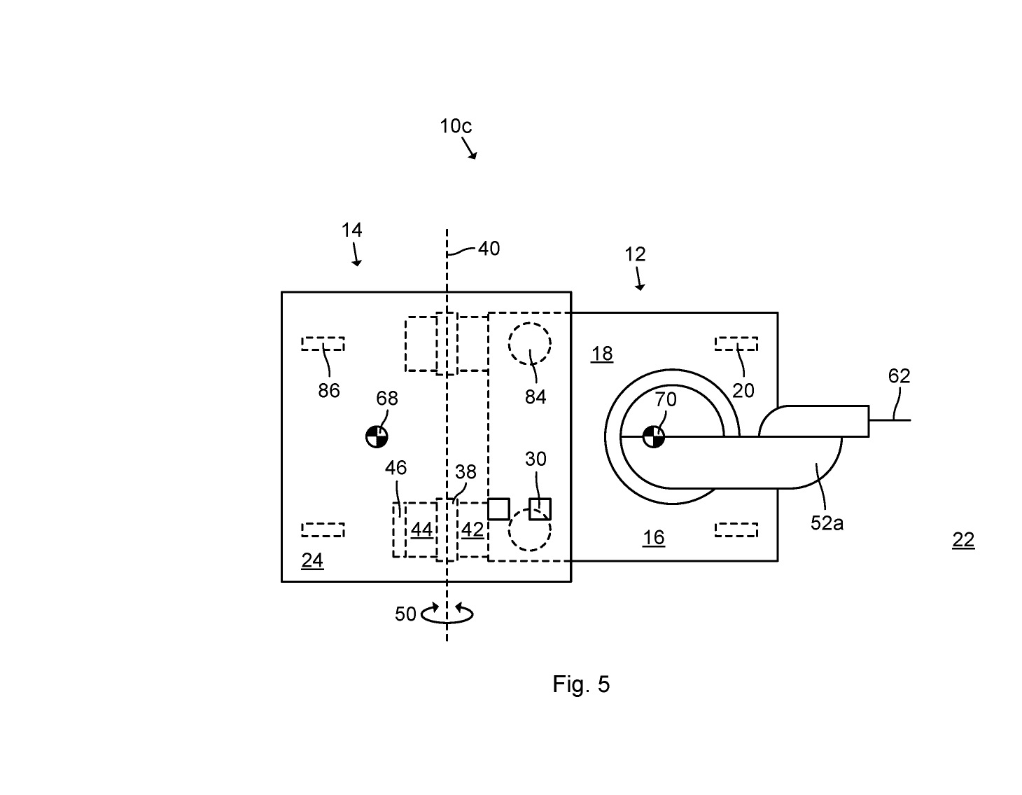

FIG. 5 schematically represents a top view of an AGV 10c according to a further example. Mainly differences from the AGV 10a will be described. Also, in the AGV 10c, the main unit 12 comprises four main wheels and the auxiliary unit 14 comprises two auxiliary wheels. However, the main wheels are here constituted by two driven main wheels 20 and two passive main wheels 84, and the auxiliary wheels are here constituted by two driven auxiliary wheels 86. Each passive main wheel 84 may be of the same type as the auxiliary wheel 26. Each auxiliary wheel 86 may be of the same type as the main wheels 20. Since the auxiliary wheels 86 are driven wheels controlled by the control system 32, the connection interface 46 of this example is both mechanical and electrical. In FIG. 5, both auxiliary wheels 86 are positioned at the same distance from the hinge axis 40.

As shown in FIG. 5, each pair of the auxiliary wheels 86, the passive main wheels 84 and the driven main wheels 20 is positioned on a respective line parallel with the hinge axis 40. The passive main wheels 84 are positioned horizontally between the auxiliary wheels 86 and the driven main wheels 20. This wheel configuration provides an improved maneuvering capacity of the AGV 10c.

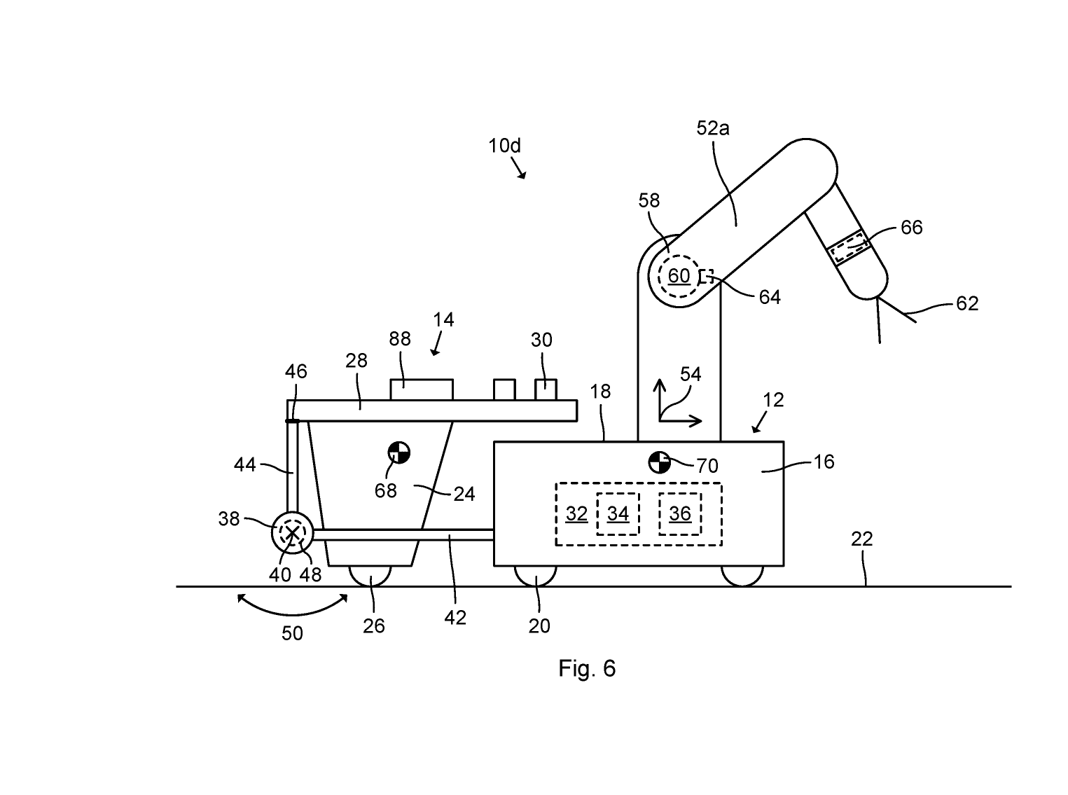

FIG. 6 schematically represents a side view of an AGV 10d according to a further example. Mainly differences from the AGV 10a will be described. In the AGV 10d, the auxiliary wheel 26 and the center of mass 68 of the auxiliary unit 14 are horizontally positioned between the hinge 38 and the main body 16. In this example, each of the main hinge part 42 and the auxiliary hinge part 44 is embodied as an elongated rod. The main hinge part 42 extends horizontally between the main body 16 and the hinge 38, and the auxiliary hinge part 44 extends vertically between the hinge 38 and the auxiliary platform 28 when the AGV 10d is positioned on the horizontal surface 22. The connection interface 46 is here arranged between the auxiliary hinge part 44 and the auxiliary platform 28.

Moreover, the AGV 10d of this example comprises a fixture 88 on the auxiliary platform 28. By docking the end effector 62 into the fixture 88 and controlling the manipulator 52a in lead-through mode where the manipulator 52a is made compliant, the position and orientation of the end effector 62, as known by the control system 32, will correspond to the position and orientation of the auxiliary platform 28 when the auxiliary body 24 rotates relative to the main body 16 around the hinge 38. Also in this way, the rotational position 50 can be determined.

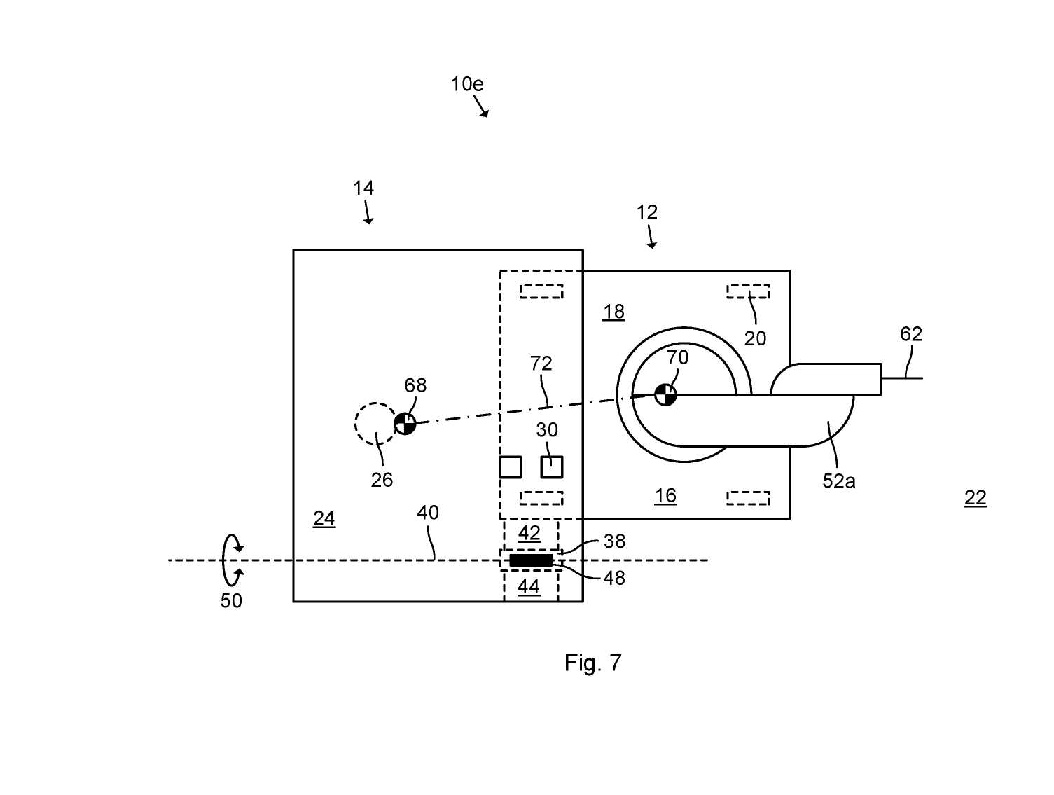

FIG. 7 schematically represents a top view of an AGV 10e according to a further example. Mainly differences from the AGV 10a will be described. In FIG. 7, the hinge 38 is positioned on a side of the main body 16 such that the hinge axis 40 is oriented substantially parallel with the line 72 between the centers of mass 68 and 70.

In the context of the present disclosure, the AGV can be designed with low complexity and can be provided at low cost. The AGV enables a modular construction and easy customization to different requirements to be met by the AGV. The auxiliary unit may be configured to carry a payload. Since the auxiliary unit comprises at least one auxiliary wheel, a payload on the auxiliary unit will be at least partly decoupled from the main unit. That is, at least a part, such as a major part, of the payload can be carried by the one or more auxiliary wheels. This implies that a single main unit can be used for a wide range of applications and that a rating of the at least one traction wheel of the main unit can be reduced.

Moreover, the AGV provides both an improved mechanical performance and an improved control performance in combination. The mechanical performance includes the ability of the AGV to handle a relatively large payload, e.g., large with respect to a rating of the main unit. The control performance includes the ability of the AGV to perform efficient motions over the horizontal surface and the ability to enable a manipulator to efficiently handle objects on the auxiliary unit.

By virtue of the auxiliary unit and the hinge, a payload on the auxiliary unit may be carried mainly or only by the auxiliary unit. That is, the main unit may not be affected by the payload on the auxiliary unit to any substantial degree. The hinge providing one degree of freedom between the main body and the auxiliary body also enables the AGV to be controlled as one single unit during navigation. Moreover, the hinge enables all wheels of the AGV to be held in contact with an uneven ground surface. Furthermore, the positioning of the center of mass of the auxiliary unit horizontally offset from the hinge axis ensures that the auxiliary body will rotate around the hinge axis as needed to bring the one or more auxiliary wheels into contact with the ground surface.

The auxiliary unit may be detachably connected to the main unit. In this way, auxiliary units of different sizes and/or types can be connected to the main unit to provide an efficient scaling of an area of a support surface and/or of a load capacity for payloads. For example, by replacing a first relatively small auxiliary unit with a second relatively large auxiliary unit connected to the main unit, the AGV is scaled to provide an increased support area and load capacity. The possibility to connect the auxiliary unit to the main unit enables a modular design of the AGV where relatively few variants of one or more main units and two or more auxiliary units can meet many different application requirements.

In the AGV, the center of mass of the auxiliary unit is horizontally offset from the hinge axis. The center of mass of the auxiliary unit may or may not be vertically offset from the hinge axis. The center of mass of the auxiliary unit may be considered without any payload on the auxiliary unit or together with a payload on the auxiliary unit. The hinge axis is horizontal when the main unit is positioned on the horizontal surface. In case the main unit is positioned on an inclined surface, the hinge axis may not be horizontal.

The auxiliary unit may, for example, be detachably connected to the hinge. In any case, in order to provide a detachable connection between the main unit and the auxiliary unit, the AGV may for example comprise a connection interface. The connection interface may for example be provided between the auxiliary unit and the hinge or between the hinge and the main unit. The connection interface may comprise a mechanical connection, e.g., comprising one or more fasteners. The connection interface may optionally further comprise an electric connection, e.g., for powering and controlling one or more traction wheels of the auxiliary unit. In case the auxiliary unit does not comprise any traction wheel, the auxiliary unit may be entirely passive. That is, no electric connection may be needed to the auxiliary unit.

Although being configured to operate with the auxiliary unit, the main unit may be configured to also operate independently without the auxiliary unit. That is, the main unit can travel over a surface also without the auxiliary unit. To this end, the main unit may comprise at least three main wheels.

The main body and the auxiliary body may be rigid, for example made of metal or hard plastic. The hinge may for example be made of metal or hard plastic. The hinge may comprise a main hinge part fixed to the main unit and an auxiliary hinge part fixed to the auxiliary unit. The auxiliary hinge part may be rotatable relative to the main hinge part about the hinge axis.

The AGV may comprise an electronic control system configured to determine the rotational position of the auxiliary body. The control system may comprise at least one data processing device and at least one memory having at least one computer program stored therein, the at least one computer program comprising program code which, when executed by the at least one data processing device, causes the at least one data processing device to determine the rotational position of the auxiliary body relative to the main body about the hinge axis. The at least one computer program may further comprise program code which, when executed by the at least one data processing device, causes the at least one data processing device to perform, or command performance of, any steps of the AGV as described herein.

The control system may be provided in the main unit. The control system may be configured to control operation of all traction wheels of the AGV to control movements of the AGV on the horizontal surface.

Each traction wheel may be controlled to rotate around a horizontal wheel axis to provide propulsion in a heading direction of the traction wheel. In addition, each traction wheel may be controlled to rotate around a vertical steering axis to provide steering of the traction wheel. To this end, the AGV may comprise a drive motor and a steering motor for each traction wheel.

The at least one auxiliary wheel may comprise one or more traction wheels and/or one or more passive wheels, such as castor wheels. In cases where all auxiliary wheels are positioned horizontally between the main unit and the center of mass of the auxiliary unit, the auxiliary unit can provide a lifting force on the main unit via the hinge. According to one variant, all auxiliary wheels of the auxiliary unit are positioned at the same distance from the hinge axis.

The hinge axis may be positioned substantially transverse to, or transverse to, a line between a center of mass of the main unit and the center of mass of the auxiliary unit. The center of mass of the main unit may be considered without a manipulator thereon or with a manipulator thereon.

At least two of the main wheels may be positioned horizontally on a common side of the hinge axis. According to some variants, all main wheels are positioned horizontally on a common side of the hinge axis.

At least two of the main wheels may be traction wheels. In these cases, the AGV may be configured to perform an omnidirectional motion of the main body. The omnidirectional motion is particularly beneficial for the AGV according to the first aspect since the AGV can be rotated around an arbitrarily chosen center point, such as a geometrical center point of the entire AGV comprising both the main unit and the auxiliary unit. This enables the entire AGV to navigate as one single unit.

The AGV may further comprise a manipulator supported on the main body. The AGV may thus be either an automated mobile robot, AMR, or an automated mobile manipulator robot, AMMR. The manipulator may as such be a commercially available manipulator.

When the AGV comprises the manipulator, the manipulator can be used to determine the rotational position of the auxiliary body. For example, if the auxiliary body comprises an auxiliary support structure of known shape fixed to the auxiliary body, e.g., of flat, cylindrical or spherical shape, the orientation of the auxiliary support structure can be determined by the control system by controlling the manipulator to be moved into contact with three unique points on the auxiliary support structure and calculating the orientation based on the positions of these points. Based on the orientation of the auxiliary support structure, the control system can determine the rotational position of the auxiliary body.

As a further example, an end effector of the manipulator can be docked to a fixture fixed on the auxiliary support structure while the manipulator is controlled in lead-through mode. In these ways, the manipulator can be used to measure a relative rotation between the auxiliary body and the main body about the hinge axis.

The control system may be configured to determine when the manipulator contacts the auxiliary support structure in various ways. In some examples, the control system monitors currents provided to actuators of the manipulator to determine when a contact is made. In some examples, the control system monitors one or more forces in the manipulator, e.g., as determined by one or more force sensors, to determine when a contact is made.

The auxiliary body may comprise an auxiliary support structure for carrying a payload. The auxiliary support structure provides a support surface for a payload, such as items to be handled by a manipulator. The auxiliary support structure may be a table.

The AGV may further comprise an auxiliary sensor arranged to provide rotation data indicative of a rotational position of the auxiliary body relative to the main body about the hinge axis. The auxiliary sensor may be configured to communicate the rotation data to the control system. The control system may then determine the rotational position of the auxiliary body based on the rotation data. The auxiliary sensor may be used instead of, or as a complement to, the determination of the rotational position of the auxiliary body using the manipulator.

According to a second aspect, there is provided a method of controlling an automated guided vehicle, AGV, the method comprising providing an AGV comprising a main unit including a main body and a plurality of main wheels supporting the main body, at least one of the main wheels being a traction wheel; an auxiliary unit including an auxiliary body and at least one auxiliary wheel supporting the auxiliary body; and a hinge connected between the main body and the auxiliary body such that the auxiliary body can rotate relative to the main body about a horizontal hinge axis; wherein the AGV is configured such that a center of mass of the auxiliary unit is horizontally offset from the hinge axis when the main body and the auxiliary unit are supported on a common horizontal surface; and determining, by the AGV, a rotational position of the auxiliary body relative to the main body about the hinge axis. The AGV in the method described in connection with the second aspect may be of any type as described in connection with the first aspect, and vice versa.

The hinge axis may be positioned substantially transverse to, or transverse to, a line between a center of mass of the main unit and the center of mass of the auxiliary unit.

At least two of the main wheels may be positioned horizontally on a common side of the hinge axis.

At least two of the main wheels may be traction wheel. In these cases, the AGV may be configured to perform an omnidirectional motion of the main body.

The AGV may further comprise a manipulator supported on the main body.

The auxiliary body may comprise an auxiliary support structure for carrying a payload.

The AGV may further comprise an auxiliary sensor arranged to provide rotation data indicative of a rotational position of the auxiliary body relative to the main body about the hinge axis. In these cases, the determination of the rotational position may be made based on the rotation data.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An automated guided vehicle (AGV), comprising:
a main unit including a main body and a plurality of main wheels supporting the main body, at least one of the plurality of main wheels being a traction wheel;
an auxiliary unit including an auxiliary body and at least one auxiliary wheel supporting the auxiliary body; and
a hinge connected between the main body and the auxiliary body such that the auxiliary body can rotate relative to the main body about a horizontal hinge axis;
wherein the AGV is configured such that a center of mass of the auxiliary unit is horizontally offset from the hinge axis when the main body and the auxiliary unit are supported on a common horizontal surface; and
wherein the AGV is configured to determine a rotational position of the auxiliary body relative to the main body about the hinge axis.

2. The AGV according to claim 1, wherein the hinge axis is positioned substantially transverse to a line between a center of mass of the main unit and the center of mass of the auxiliary unit.

3. The AGV according to claim 1, wherein at least two of the plurality of main wheels are positioned horizontally on a common side of the hinge axis.

4. The AGV according to claim 1, wherein at least two of the plurality of main wheels are traction wheels; and wherein the AGV is configured to perform an omnidirectional motion of the main body.

5. The AGV according to claim 1, further comprising a manipulator supported on the main body.

6. The AGV according to claim 1, wherein the auxiliary body comprises an auxiliary support structure for carrying a payload.

7. The AGV according to claim 1, further comprising an auxiliary sensor arranged to provide rotation data indicative of a rotational position of the auxiliary body relative to the main body about the hinge axis.

8. A method of controlling an automated guided vehicle (AGV), the method comprising:
providing an AGV comprising a main unit including a main body and a plurality of main wheels supporting the main body, wherein at least one of the plurality of main wheels is a traction wheel;
providing an auxiliary unit including an auxiliary body and at least one auxiliary wheel supporting the auxiliary body; and
providing a hinge connected between the main body and the auxiliary body such that the auxiliary body is rotatable relative to the main body about a horizontal hinge axis;
wherein the AGV is configured such that a center of mass of the auxiliary unit is horizontally offset from the hinge axis when the main body and the auxiliary unit are supported on a common horizontal surface; and
determining, by the AGV, a rotational position of the auxiliary body relative to the main body about the hinge axis.

9. The method according to claim 8, wherein the hinge axis is positioned substantially transverse to a line between a center of mass of the main unit and the center of mass of the auxiliary unit.

10. The method according to claim 8, wherein at least two of the main wheels are positioned horizontally on a common side of the hinge axis.

11. The method according to claim 8, wherein at least two of the main wheels are traction wheel; and wherein the AGV is configured to perform an omnidirectional motion of the main body.

12. The method according to claim 8, wherein the AGV further comprises a manipulator supported on the main body.

13. The method according to claim 8, wherein the auxiliary body comprises an auxiliary support structure for carrying a payload.

14. The method according to claim 8, wherein the AGV further comprises an auxiliary sensor arranged to provide rotation data indicative of a rotational position of the auxiliary body relative to the main body about the hinge axis, and wherein the determination of the rotational position is made based on the rotation data.
